(19) United States
(12) Patent Application Publication
(10) Pub. No.: US 2009/0190278 A1
(43) Pub. Date: Jul. 30, 2009

(54) ELECTRONIC DEVICE HAVING REVERSE CONNECTION PROTECTION CIRCUIT

(75) Inventors: LUNG DAI, Tu-Cheng (TW); YONG-SONG SHI, Shenzhen City (CN); QIAO-LIN DENG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/324,848

(22) Filed: Nov. 27, 2008

(30) Foreign Application Priority Data
Jan. 25, 2008 (CN) 200810300223.4

(51) Int. Cl. H02H 3/00

(52) U.S. Cl. 361/84

(57) ABSTRACT

An electronic device includes an operation circuit, a positive input terminal, a negative input terminal, a resistor, and a field effect transistor. The negative input terminal is used for cooperating with the positive input terminal to receive an input voltage. The field effect transistor includes a source connected to the positive input terminal, a drain connected to the operation circuit, and a gate connected to the positive input terminal and the operation circuit via the resistor.

### BACKGROUND

1. Field of the Disclosure

Embodiments of the present disclosure relate to electronic devices, and particularly to an electronic device having a reverse connection protection circuit.

2. Description of Related Art

Many electronic devices are powered by direct current (DC) power supply. If the electronic devices are reversely connected to the DC power supply, the electronic device may be damaged. Thus, reverse connection protection circuits are used in the electronic device.

Referring to FIGS. 2 and 3, in an electronic device 10, a reverse connection protection circuit 200 is connected between a power input connector 100 and an operation circuit 300. The reverse connection protection circuit 200 includes a diode D1. The power input connector 100 includes a positive input terminal 102 and a negative input terminal 104. The anode of the diode D1 is connected to the positive input terminal 102, and the cathode of the diode D1 is connected to the operation circuit 300. The negative input terminal 104 is directly connected to the operation circuit 300. When a power supply is correctly connected to the power input connector 100, the diode D1 is turned on, and an input power is conducted to the operation circuit 300. When the power supply is reversely connected to the power input connector 100, the diode D1 is turned off, and there is no power to the operation circuit 300. Therefore, the operation circuit 300 is protected from being damaged by the reverse connection.

However, the diode D1 has a large impedance, and, proportionally, a large voltage drop will be across the diode D1 under a low-input-voltage condition. Therefore, in order to drive the operation circuit 300, a voltage with a quite big value is inevitably to be provided, which is reverse to our energy saving idea today. Especially, the large impedance of the diode D1 will lead to high power consumption.

Therefore, an improved reverse connection protection device capable of protecting an electronic device from being damaged by a reverse connection to a power supply is needed to address the aforementioned deficiency and inadequacies.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a structure of an electronic device in accordance with an embodiment of the present disclosure.

FIG. 2 is a block diagram of an electronic device in accordance with a related art.

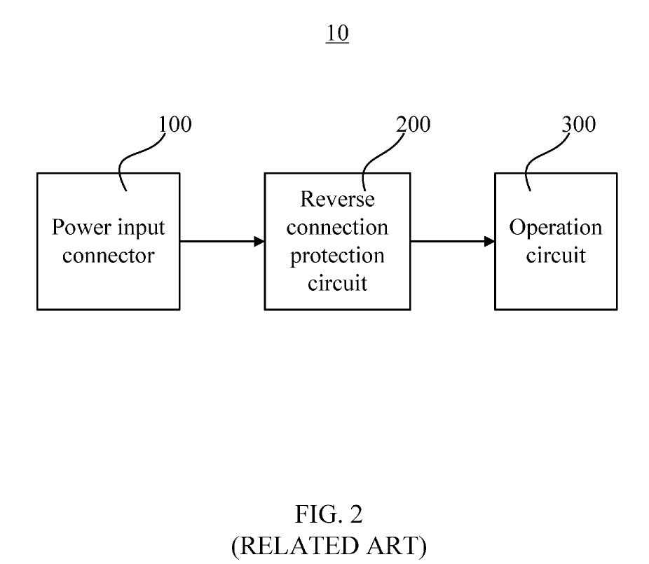

FIG. 3 is a schematic diagram showing a structure of the electronic device of FIG. 2.

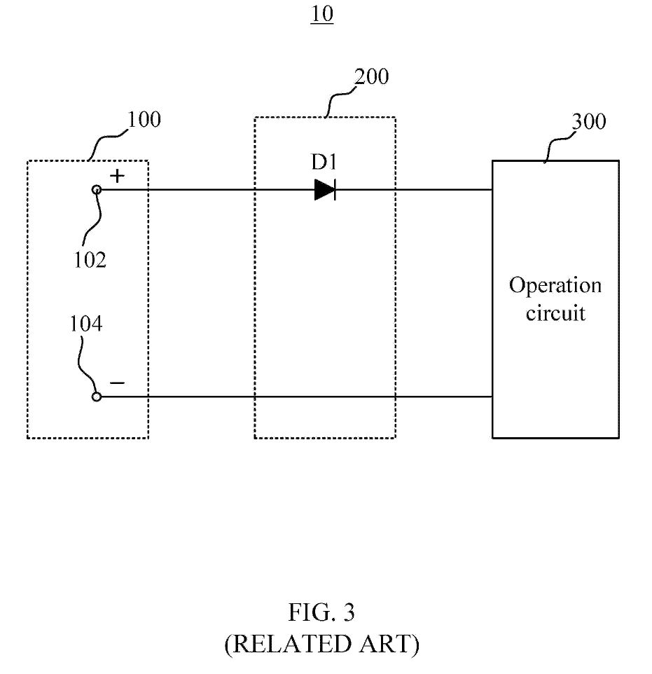

### DETAILED DESCRIPTION OF CERTAIN INVENTIVE EMBODIMENTS

References will now be made to the drawings to describe certain inventive embodiments of the present disclosure.

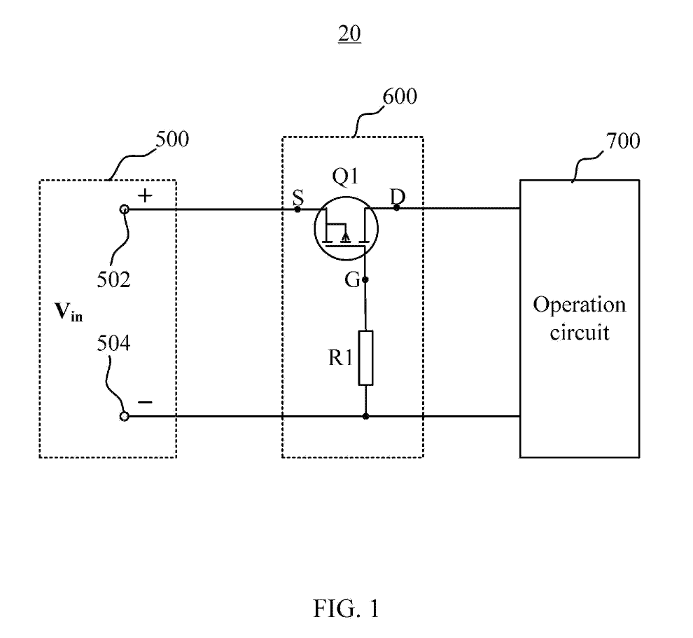

Referring to FIG. 1, an electronic device 20 in accordance with an exemplary embodiment is illustrated. The electronic device 20 includes a power input connector 500, a reverse connection protection circuit 600, and an operation circuit 700. The operation circuit 700 is capable of being powered on by an external direct current (DC) power supply.

The power input connector 500 is used for receiving and transmitting the input voltage Vin to the reverse connection protection circuit 600. The power input connector 500 includes a positive input terminal 502 and a negative input terminal 504 for connecting to the DC power supply to receive an input voltage Vin.

The reverse connection protection circuit 600 is connected between the power input connector 500 and the operation circuit 700. The reverse connection protection circuit 600 is configured for preventing the operation circuit 700 from damages caused by reverse current/voltages.

In this embodiment, the reverse connection protection circuit 600 includes a field effect transistor (FET) Q1 and a resistor R1. The FET Q1 is a P-Channel enhancement type FET. A source S of the FET Q1 is connected to the positive input terminal 502 of the power input connector 500. A drain D of the FET Q1 is connected to the operation circuit 700. A gate G of the FET Q1 is connected to a terminal of the resistor R1. The other terminal of the resistor R1 is connected to the negative input terminal 504 of the power input connector 500 and the operation circuit 700.

In operation, when the input voltage Vin is positive, a voltage difference between the source and gate of the FET Q1 is positive, and substantially equals to the input voltage Vin. Thus the FET Q1 turns on. Because an on-state drain-to-source impedance of an FET is very small, about 0.05 ohms, only a small proportion of a voltage drop will be supplied to the FET Q1 and is negligible. Thus, the input voltage Vin is substantially the same across the operation unit 700. Therefore the operation of the operation circuit 700 will not be affected. Furthermore, power consumption of the FET Q1 is low.

When the input voltage Vin is negative, the voltage difference between the source and gate of the FET Q1 is negative. Thus the FET Q1 turns off. No power is transmitted to the operation unit 700.

Because of an effect produced by a capacitance across the source and gate of the FET Q1, the FET Q1 may generate a surge current that flows through the source and gate of the FET Q1. The resistor R1 is used for reducing the surge current and protecting the FET Q1.

It is to be understood, however, that even though numerous characteristics and advantages of the present disclosure have been set forth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device, comprising:
an operation circuit;
a positive input terminal;
a negative input terminal for cooperating with the positive input terminal to receive an input voltage;
a resistor; and
a field effect transistor comprising a source connected to the positive input terminal, a drain connected to the operation circuit, and a gate connected to the positive input terminal and the operation circuit via the resistor.

2. The electronic device as claimed in claim 1, wherein the field effect transistor is a P-Channel enhancement type field effect transistor.

3. An electronic device capable of receiving an input voltage, comprising:
an operation circuit;
a resistor; and
a field effect transistor cooperatively combining with the resistor to protect the operation circuit from being damaged when the input voltage is reverse;
wherein in the field effect transistor, a source and a terminal of the resistor receiving the input voltage, a drain and the terminal of the resistor outputting the input voltage to the operation circuit when the input voltage is positive, and the other terminal of the resistor is connected to a gate.
